(19) United States
(12) Patent Application Publication
(10) Pub. No.: US 2026/0323637 A1
(43) Pub. Date: Oct. 15, 2026

(54) SYSTEMS AND METHODS FOR UPLINK PROCESSING TIME DETERMINATIONS FOR SINGLE DOWNLINK CONTROL INFORMATION SCHEDULING MULTIPLE CELLS

(71) Applicant: APPLE INC., Cupertino, CA (US)

(72) Inventors: Haitong Sun, Cupertino, CA (US); Wei Zeng, San Diego, CA (US); Sigen Ye, San Diego, CA (US); Chunxuan Ye, San Diego, CA (US); Huaning Niu, San Jose, CA (US); Chunhai Yao, Beijing (CN); Xiang Chen, Campbell, CA (US); Dawei Zhang, Saratoga, CA (US)

(21) Appl. No.: 18/998,714

(22) PCT Filed: Aug. 9, 2022
(86) PCT No.: PCT/CN2022/111146

§ 371 Date: Jan. 27, 2025

(51) Int. Cl. H04W 72/1273; H04W 72/232

(52) U.S. Cl. CPC H04W 72/1273; H04W 72/232

(57) ABSTRACT

Wireless communications systems using a single downlink control information (DCI) to schedule multiple physical uplink shared channels (PUSCHs) or multiple aperiodic (AP) sounding reference signals (SRSs) (AP-SRSs) on multiple cells at a user equipment (UE) are discussed. In the case of scheduling multiple PUSCHs, a K2 value restriction for each PUSCH may be calculated. In some cases, these are calculated independently, while in others, one or more determined values relative to one of the PUSCHs is used to calculate a K2 value restriction for all the PUSCHs scheduled by the DCI. In the case of scheduling multiple AP-SRSs, a time offset value restriction for each PUSCH may be calculated. In some cases, these are calculated independently, while in others, one or more determined values relative to one of the AP-SRSs is used to calculate a time offset value restriction for all the AP-SRSs scheduled by the DCI.

### TECHNICAL FIELD

This application relates generally to wireless communication systems, including wireless communications systems that use single DCI to schedule multiple PUSCHs or multiple AP-SRSs on multiple cells.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi©).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram showing a scheduling restriction between a P(S)Cell and an SCell.

FIG. 2 illustrates a diagram showing a scheduling restriction between a first cell, a second cell, and a third cell.

FIG. 3 illustrates a diagram showing a scheduling restriction between a first cell, a second cell, and a third cell.

FIG. 4 illustrates a diagram showing scheduling mechanisms that are useable for a P(S)Cell with relaxed restrictions.

FIG. 5 illustrates a diagram showing a relationship between a DCI and a PUSCH that is scheduled by the DCI, according to embodiments herein.

FIG. 6 illustrates a pair of tables corresponding to the determination of a parameter N₂, according to embodiments herein.

FIG. 7 illustrates a method of a UE, according to embodiments herein.

FIG. 8 illustrates a diagram showing a relationship between a DCI and an AP-SRS that is scheduled by the DCI, according to embodiments herein

FIG. 9 illustrates a method of a UE, according to embodiments herein.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Discussion herein may relate to a primary cell of a master cell group (MCG) (a “PCell”) and/or a primary cell of a secondary cell group (SCG) (a “PSCell”). As will be understood, each of a PCell and a PSCell may be an example of a special cell (a “SpCell”). Herein, “P(S)Cell” may be used in descriptions that apply to either a PCell or a PSCell.

Embodiments herein contemplate that downlink control information (DCI) may be received at a UE on a first serving cell used by the UE, and that the DCI may schedules activity on a second serving cell used by the UE. This process may be referred to herein as cross-carrier scheduling (CCS).

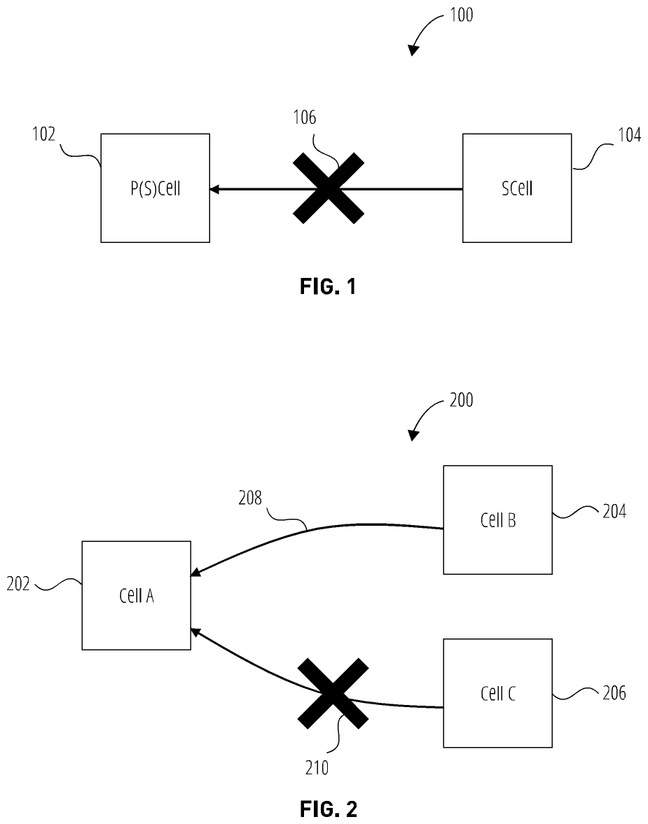

In some wireless communication systems, there may be restrictions on the use of CCS. In some such systems, it may be that a P(S)Cell may only be scheduled by itself (e.g., it cannot be scheduled via CSS). FIG. 1 illustrates a diagram 100 showing a scheduling restriction between a P(S)Cell 102 and a secondary cell (SCell) 104. The diagram 100 shows that the SCell 104 corresponding to the P(S)Cell 102 (e.g., that is part of a cell group of the P(S)Cell) is not usable 106 to schedule activity on the P(S)Cell 102.

In some wireless communication systems, it may be that, for a first cell, there may be only a single other cell that is configured (e.g., via radio resource control (RRC)) to schedule activity on the first cell. FIG. 2 illustrates a diagram 200 showing a scheduling restriction between a first cell 202 (“Cell A”), a second cell 204 (“Cell B”), and a third cell 206 (“Cell C”). The diagram 200 shows that that the first cell 202 may be scheduled 208 by the second cell 204 (which is configured for this purpose). Due to this relationship between the first cell 202 and the second cell 204, the third cell 206 is not usable 210 to schedule activity on the first cell 202.

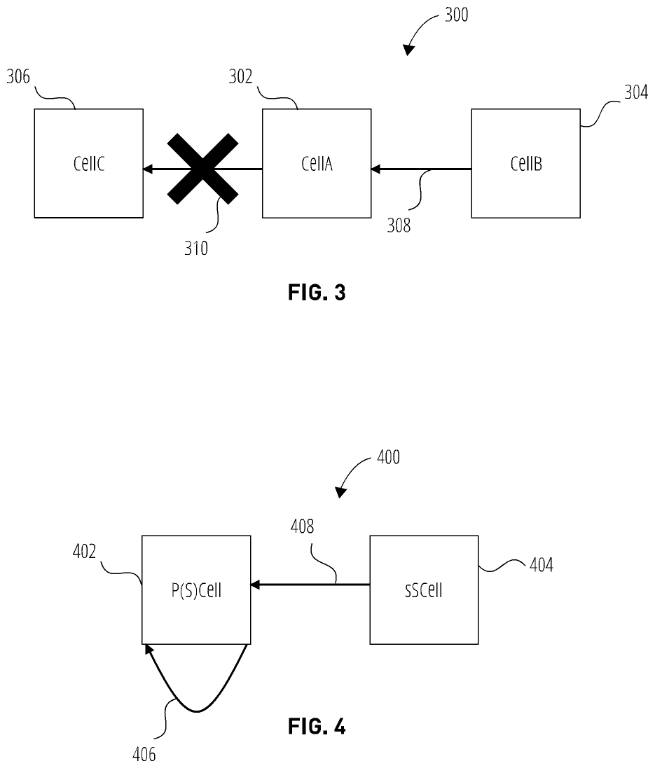

In some wireless communication systems, it may be that a cell that is configured to be scheduled by another cell cannot itself schedule activity on another cell. FIG. 3 illustrates a diagram 300 showing a scheduling restriction between a first cell 302 (“Cell A”), a second cell 304 (“Cell B”), and a third cell 306 (“Cell C”). The diagram 300 shows that that the first cell 302 may be scheduled 308 by the second cell 304 (which is configured for this purpose). Due to this relationship between the first cell 302 and the second cell 304, the first cell 302 is not usable 310 to schedule activity on the third cell 306.

In some wireless communication systems, it may be that cross cell group (CG) and/or cross physical uplink control channel (PUCCH) group scheduling is not supported.

In some wireless communication systems, restrictions may be relaxed in order to provide scheduling flexibility to a primary cell. FIG. 4 illustrates a diagram 400 showing scheduling mechanisms that are useable for a P(S)Cell 402 with relaxed restrictions. The diagram 400 shows that the P(S)Cell 402 can schedule 406 itself. Further, an sSCell 404 of the P(S)Cell 402 is also illustrated, where the sSCell 404 is an SCell corresponding to the P(S)Cell 402 that is configured to (also) schedule 408 the P(S)Cell 402.

The use of the sSCell 404 to perform scheduling for the P(S)Cell 402 in this manner may provide scheduling flexibility to the network in the case when, for example, the P(S)Cell 402 coexists with LTE, and physical downlink control channel (PDCCH) monitoring on P(S)Cell is restricted due to LTE cell-specific reference signal (CRS) use.

The ability to use the sSCell 404 for scheduling the P(S)Cell 402 gives additional flexibility over, for example, embodiments according to the discussion of the SCell 104 and the P(S)Cell 102 in the diagram 100 of FIG. 1.

In some wireless communication systems, it may be that a single DCI can be used to schedule physical downlink shared channel(s) (PDSCH(s))/physical uplink shared channels (PUSCH(s)) on one cell. In such cases, the scheduled cell may be indicated by a “carrier indicator” field in the DCI. A mapping of the carrier indicator field to the corresponding cell may be configured by RRC via, for example, a CrossCarrierSchedulingConfig information element (IE). Such configurations may be per scheduled cell.

To promote additional scheduling flexibility within a wireless communication system, it is beneficial to implement the use of single DCI that can schedule multiple PDSCHs/PUSCHs/sounding reference signals (SRSs) on multiple cells. In some such cases, it may be that the DCI schedules one PDSCH/PUSCH on each of the multiple cells. Such operation in both inter- and intra-band carrier aggregation (CA) scenarios may be considered. Such operation in both FR1 and FR2 may be considered. A single DCI scheduling multiple PDSCH/PUSCH on multiple cells may perform such scheduling on two cells, 3 or more cells, etc., in various cases.

Embodiments herein relate to minimum permitted times between a (single) DCI and the (multiple) sets of physical channels and/or signals scheduled by that DCI. For example, some embodiments herein relate to the minimum permitted times between the (single) DCI and each of (multiple) PUSCHs scheduled by that DCI. Further, some embodiments herein relate to the minimum permitted times between the (single) DCI and each of (multiple) aperiodic (AP) SRSs (AP-SRSs) scheduled by that DCI. In various embodiments, such minimum permitted times may represent and/or include processing times for the UE to successfully prepare the scheduled PUSCHs/AP-SRSs for transmission according to the timing given in the DCI.

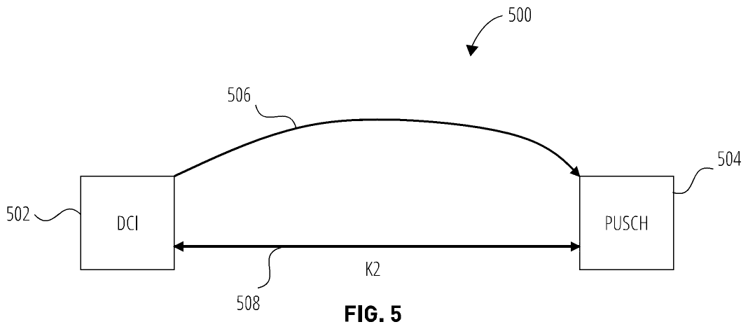

FIG. 5 illustrates a diagram 500 showing a relationship between a DCI 502 and a PUSCH 504 that is scheduled by the DCI 502, according to embodiments herein. The DCI 502 is sent by a network in downlink (DL) and received at a UE. The DCI 502 schedules 506 a PUSCH 504 for use by the UE in uplink (UL). As illustrated, it may be understood that a K2 value 508 represents the time between the DCI 502 that schedules the PUSCH 504 and the PUSCH 504. In some cases, the K2 value 508 may be measured in slots (e.g., the K2 value represents the slots between the slot of the DCI 502 and the slot of the PUSCH 504). In other cases, the K2 value 508 may be measured in symbols (e.g., the K2 value 508 represents the symbols between the end of the PDCCH carrying the DCI 502 and the beginning of the PUSCH 504).

Embodiments herein relate to the determination and use of restrictions on K2 values. For example, it may be that one way of determining a K2 value restriction corresponding to a K2 value for a PUSCH scheduled by a DCI uses the formula

$${T}_{proc , 2} = max ( ( {N}_{2} + {d}_{2 , 1} + {d}_{2} ) ( 2048 + 144 ) \cdot {κ2}^{- μ} \cdot {T}_{c} + {T}_{ext} + {T}_{switch} , {d}_{2 , 2} ) ,$$

where:
T_{proc,2} is the K2 value restriction corresponding to the K2 value for the PUSCH;
N₂ is a time offset amount that is determined based on a UE processing capability according to a definition for the wireless communication system in which the UE operates, and that is based on a subcarrier spacing (SCS) of the scheduled PUSCH and an SCS of a PDCCH carrying the scheduling DCI;
d_{2,1} is an additional relaxation parameter that is determined based on whether a first symbol of the scheduled PUSCH is for a demodulation reference signal (DM-RS);
d₂ is an additional relaxation parameter that is determined based on whether the scheduled PUSCH overlaps with a physical uplink control channel (PUCCH) and has a priority index that is larger than a priority index of the PUCCH;
d_{2,2} is a parameter that is determined based on whether the DCI triggers a bandwidth part (BWP) switch in a serving cell of the scheduled PUSCH;
κ is a physical layer timing unit constant;
T_{c} is a maximum sampling time within the wireless communication system;
μ corresponds to an SCS of the PUSCH;
Tₑₓₜ is determined based on an operation in an unlicensed band (if any); and
T_{switch} is an applicable antenna UL switching gap (if any).

The value T_{proc,2} may be in units of symbols in some embodiments. Then, the check for the restriction on the K2 value corresponding to the calculated T_{proc,2} ensures that there are at least T_{proc,2} symbols between the end of the reception of the last symbol of the PDCCH carrying the DCI and the first UL symbol in the PUSCH allocation (which is understood to be at a slot that is K2 slots from the slot of the DCI/at a symbol that is K2 symbols from the end of the PDCCH carrying the DCI, depending on the mechanism for understanding K2 that is used).

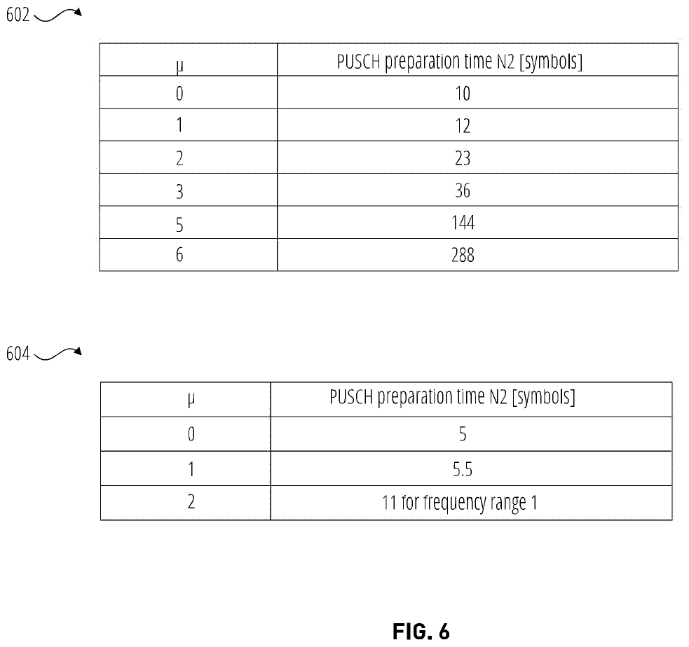

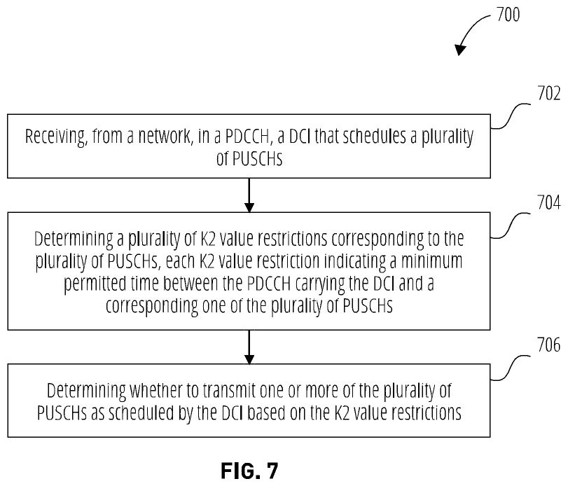

FIG. 6 illustrates a pair of tables 602, 604 corresponding to the determination of a parameter N₂, according to embodiments herein. The first table 602 may be used by a UE having a first PUSCH timing capability, while the second table 604 may be used by a UE having a second PUSCH timing capability. In both cases, the value p used by the UE corresponds to the one of (μ_{DL}, μ_{UL}) that ultimately results with the largest T_{proc,2}, where μ_{DL} corresponds to the subcarrier spacing of the downlink with which the PDCCH carrying the DCI scheduling the PUSCH is transmitted, and p_{UL} corresponds to the subcarrier spacing of the uplink channel with which the PUSCH is to be transmitted.

It may be that a UE determines N2 using the one of the first table 602 and the second table 604 that corresponds to a UE PUSCH timing capability (e.g., a processing capability). The relevant capability may be, for example, a capability that has been reported to the network.

Embodiments herein relate to the implementation of restrictions on K2 values for each of (multiple) PUSCHs in different cells that are scheduled by a (single) DCI.

In some cases where a single DCI schedules multiple PUSCHs in different cells, a K2 value restriction may be determined independently for each scheduled PUSCH. These independent determinations for each PUSCH may be based on, for example: an SCS of the scheduled PUSCH and an SCS of the PDCCH carrying the scheduling DCI (e.g., based on an N₂ value calculated independently for the PUSCH using these values); whether the first symbol of the PUSCH allocation consists of DM-RS (e.g., a d_{2,1} value calculated independently for the PUSCH); and/or whether the scheduled PUSCH overlaps with a PUCCH and has a priority index that is larger than a priority index of the PUCCH (e.g., a d₂ value calculated independently for the PUSCH); etc. These values may be used in, for example, the formula for T_{proc,2} described herein independently for each PUSCH to arrive at the independent K2 value restriction for each PUSCH.

In other cases where a single DCI schedules multiple PUSCHs in different cells, a K2 value restriction for each PUSCH scheduled by the DCI may be calculated in a manner that is dependent on the timing and/or nature of other PUSCH(s) scheduled by that DCI.

In a first alternative of dependent K2 value restriction calculation mechanisms, largest determined value(s) as among all PUSCHs may be used in determinations of K2 value restrictions for each PUSCH.

For example, the UE determines an N₂ value (e.g., as described herein) for each of the PUSCHs. Then, the UE determines a largest N₂ value from this set of N₂ values. Then, when calculating K2 value restrictions for each of the PUSCHs scheduled by the DCI (e.g., using the formula for T_{proc,2} described herein), this largest N₂ value is used in each such calculation for a corresponding scheduled PUSCH.

Additionally or alternatively, the UE determines a d_{2,1} value (e.g., as described herein) for each of the PUSCHs. Then, the UE determines a largest d_{2,1} value from this set of d_{2,1} values. Then, when calculating K2 value restrictions for each of the PUSCHs scheduled by the DCI (e.g., using the formula for T_{proc,2} described herein), this largest d_{2,1} value is used in each such calculation for a corresponding scheduled PUSCH.

Additionally or alternatively, the UE determines a d₂ value (e.g., as described herein) for each of the PUSCHs. Then, the UE determines a largest d₂ value from this set of d₂ values. Then, when calculating K2 value restrictions for each of the PUSCHs scheduled by the DCI (e.g., using the formula for T_{proc,2} described herein), this largest d₂ value is used in each such calculation for a corresponding scheduled PUSCH.

Additionally or alternatively, the UE determines a d_{2,2} value (e.g., as described herein) for each of the PUSCHs. Then, the UE determines a largest d_{2,2} value from this set of d_{2,2} values. Then, when calculating K2 value restrictions for each of the PUSCHs scheduled by the DCI (e.g., using the formula for T_{proc,2} described herein), this largest d_{2,2} value is used in each such calculation for a corresponding scheduled PUSCH.

In a second alternative of dependent K2 value restriction calculation mechanisms, determined value(s) of an earliest PUSCH as among all the scheduled PUSCHs may be used to calculate a K2 value restriction for each scheduled PUSCH. In such cases, the UE identifies an earliest scheduled PUSCH among all PUSCHs scheduled by the DCI. The determination of the earliest scheduled PUSCH may be based on the beginning locations of the PUSCHs in some embodiments, while other embodiments may use determinations of an earliest scheduled PUSCH based on the ending locations of the PUSCHs.

Then, the UE determines an N₂ value (e.g., as described herein) for the earliest PUSCH. Then, when calculating K2 value restrictions for each of the PUSCHs scheduled by the DCI (e.g., using the formula for T_{proc,2} described herein), this N₂ value for the earliest PUSCH is used in each such calculation for the corresponding scheduled PUSCH.

Additionally or alternatively, the UE determines a d_{2,1} value (e.g., as described herein) for the earliest PUSCH. Then, when calculating K2 value restrictions for each of the PUSCHs scheduled by the DCI (e.g., using the formula for T_{proc,2} described herein), this d_{2,1} value for the earliest PUSCH is used in each such calculation for the corresponding scheduled PUSCH.

Additionally or alternatively, the UE determines a d₂ value (e.g., as described herein) for the earliest PUSCH. Then, when calculating K2 value restrictions for each of the PUSCHs scheduled by the DCI (e.g., using the formula for T_{proc,2} described herein), this d₂ value for the earliest PUSCH is used in each such calculation for the corresponding scheduled PUSCH.

Additionally or alternatively, the UE determines a d_{2,2} value (e.g., as described herein) for the earliest PUSCH. Then, when calculating K2 value restrictions for each of the PUSCHs scheduled by the DCI (e.g., using the formula for T_{proc,2} described herein), this d_{2,2} value for the earliest PUSCH is used in each such calculation for the corresponding scheduled PUSCH.

In a third alternative of dependent K2 value restriction calculation mechanisms, determined value(s) of a latest PUSCH as among all the scheduled PUSCHs may be used to calculate a K2 value restriction for each scheduled PUSCH. In such cases, the UE identifies a latest scheduled PUSCH among all PUSCHs scheduled by the DCI. The determination of the latest scheduled PUSCH may be based on the beginning locations of the PUSCHs in some embodiments, while other embodiments may use determinations of a latest scheduled PUSCH based on the ending locations of the PUSCHs.

Then, the UE determines an N₂ value (e.g., as described herein) for the latest PUSCH. Then, when calculating K2 value restrictions for each of the PUSCHs scheduled by the DCI (e.g., using the formula for T_{proc,2} described herein), this N₂ value for the latest PUSCH is used in each such calculation for the corresponding scheduled PUSCH.

Additionally or alternatively, the UE determines a d_{2,1} value (e.g., as described herein) for the latest PUSCH. Then, when calculating K2 value restrictions for each of the PUSCHs scheduled by the DCI (e.g., using the formula for T_{proc,2} described herein), this d_{2,1} value for the latest PUSCH is used in each such calculation for the corresponding scheduled PUSCH.

Additionally or alternatively, the UE determines a d₂ value (e.g., as described herein) for the latest PUSCH. Then, when calculating K2 value restrictions for each of the PUSCHs scheduled by the DCI (e.g., using the formula for T_{proc,2} described herein), this d₂ value for the latest PUSCH is used in each such calculation for the corresponding scheduled PUSCH.

Additionally or alternatively, the UE determines a d_{2,2} value (e.g., as described herein) for the latest PUSCH. Then, when calculating K2 value restrictions for each of the PUSCHs scheduled by the DCI (e.g., using the formula for T_{proc,2} described herein), this d_{2,2} value for the latest PUSCH is used in each such calculation for the corresponding scheduled PUSCH.

In some cases where a single DCI schedules multiple PUSCHs in different cells, an additional time offset may be used at the UE (e.g., to account for the additional general complexity of the multi-cell scheduling). This additional time offset may be in the form of an offset extension indicating an additional number of symbols to be counted as part of the K2 value restriction as between a PDCCH carrying the DCI and the scheduled PUSCH (e.g., in addition to a size of a K2 value restriction that is generated by methods already discussed). This offset extension may be independently determined for each scheduled PUSCH, based on the SCS of the scheduled PUSCH and the SCS of the PDCCH carrying the DCI.

In some cases, this offset extension may be determined based on a pre-determined arrangement corresponding to the SCS of the scheduled PUSCH and the SCS of the PDCCH carrying the DCI as defined for the wireless communication system.

In some cases, this offset extension may further correspond to a processing capability of the UE (e.g., where the processing capability of the UE may control, the particular manner of applying the SCS of the scheduled PUSCH and/or the SCS of the PDCCH carrying the DCI to arrive at the offset extension). The processing capability so used may be a processing capability that is/has been reported to the network.

In cases where a single DCI schedules multiple PUSCHs in different cells, it may be that the UE determines whether (or not) to transmit one or more of the PUSCHs based on the K2 value restrictions for the PUSCHs.

In first such cases, the UE may identify one or more compliant PUSCHs of the plurality of PUSCHs, where each compliant PUSCHs is a PUSCH that is scheduled (e.g., according to its K2 value) after the PDCCH carrying the DCI by at least the minimum permitted time indicated by the K2 value restriction corresponding to the PUSCH. Then the UE may proceed to transmit the one or more compliant PUSCHs. The UE may further identify non-compliant PUSCHs, where each non-compliant PUSCH is a PUSCH that is scheduled (e.g., according to its K2 value) after the PDCCH carrying the DCI by less than the minimum permitted time indicated by the K2 value restriction corresponding to the PUSCH. The UE may not transmit these non-compliant PUSCHs.

In second such cases, the UE may identify one or more non-compliant PUSCHs, where each non-compliant PUSCH is a PUSCH that is scheduled (e.g., according to its K2 value) after the PDCCH carrying the DCI by less than the minimum permitted time indicated by the K2 value restriction corresponding to the PUSCH. In this second case, it may be that the UE may not transmit any of the PUSCHs scheduled by the DCI (e.g., even dropping those PUSCH(s) that are compliant as discussed above (if any)) as a response to the identification of the one or more non-compliant PUSCHs.

It is noted that similar considerations may apply in the case of scheduling multiple PDSCHs in different cells by a single DCI.

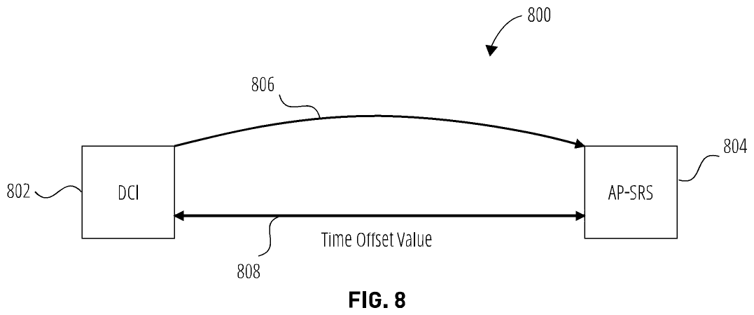

FIG. 7 illustrates a method 700 of a UE, according to embodiments herein. The method 700 includes receiving 702, from a network, in a PDCCH, a DCI that schedules a plurality of PUSCHs.

The method 700 further includes determining 704 a plurality of K2 value restrictions corresponding to the plurality of PUSCHs, each K2 value restriction indicating a minimum permitted time between the PDCCH carrying the DCI and a corresponding one of the plurality of PUSCHs.

The method 700 further includes determining 706 whether to transmit one or more of the plurality of PUSCHs as scheduled by the DCI based on the K2 value restrictions.

In some embodiments of the method 700, the determining the plurality of K2 value restrictions includes determining a K2 value restriction of the plurality of K2 value restrictions for a corresponding PUSCH of the plurality of PUSCHs based on a value N₂ that is determined based on an SCS of the corresponding PUSCH and an SCS of the PDCCH carrying the DCI, a value d_{2,1} that is determined based on whether a first symbol of the corresponding PUSCH is for a DM-RS, and a value d₂ that is determined based on whether the corresponding PUSCH overlaps with a PUCCH and has a first priority index that is larger than a second priority index of the PUCCH.

In some embodiments of the method 700, the determining the plurality of K2 value restrictions includes determining a set of values N₂ corresponding to the plurality of PUSCHs, wherein each value N₂ is based on SCS of one of the plurality of PUSCHs and an SCS of the PDCCH carrying the DCI, determining a largest value N₂ from among the set of values N₂, and determining each K2 value restriction of the plurality of K2 value restrictions based on the largest value N₂ from among the set of values N₂.

In some embodiments of the method 700, the determining the plurality of K2 value restrictions includes determining a set of values d_{2,1} corresponding to the plurality of PUSCHs, wherein each value d_{2,1} is based on whether a first symbol of one of the plurality of PUSCHs is for a DM-RS, determining a largest value d_{2,1} from among the set of values d_{2,1}, and determining each K2 value restriction of the plurality of K2 value restrictions based on the largest value d_{2,1} from among the set of values d_{2,1}.

In some embodiments of the method 700, the determining the plurality of K2 value restrictions includes determining a set of values d₂ corresponding to the plurality of PUSCHs, wherein each value d₂ is based on whether one of the plurality of PUSCHs overlaps with a PUCCH and has a first priority index that is larger than a second priority index of the PUCCH, determining a largest value d₂ from among the set of values d₂, and determining each K2 value restriction of the plurality of K2 value restrictions based on the largest value d₂ from among the set of values d₂.

In some embodiments of the method 700, the determining the plurality of K2 value restrictions includes determining a set of values d_{2,2} corresponding to the plurality of PUSCHs, wherein each value d_{2,2} is based on whether the DCI triggers a BWP switch in a serving cell of one of the plurality of PUSCHs, determining a largest value d_{2,2} from among the set of values d_{2,2}, and determining each K2 value restriction of the plurality of K2 value restrictions based on the largest value d_{2,2} from among the set of values d_{2,2}.

In some embodiments of the method 700, the determining the plurality of K2 value restrictions includes identifying an earliest PUSCH of the plurality of PUSCHs, determining a value N₂ that is based on a SCS of the earliest PUSCH and an SCS of the PDCCH carrying the DCI, and determining each K2 value restriction of the plurality of K2 value restrictions based on the value N₂.

In some embodiments of the method 700, the determining the plurality of K2 value restrictions includes identifying an earliest PUSCH of the plurality of PUSCHs, determining a value d_{2,1} that is based on whether a first symbol of the earliest PUSCH is for a DM-RS, and determining each K2 value restriction of the plurality of K2 value restrictions based on the value d_{2,1}.

In some embodiments of the method 700, the determining the plurality of K2 value restrictions includes identifying an earliest PUSCH of the plurality of PUSCHs, determining a value d₂ that is based on whether the earliest PUSCH overlaps with a PUCCH and has a first priority index that is larger than a second priority index of the PUCCH, and determining each K2 value restriction of the plurality of K2 value restrictions based on the value d₂.

In some embodiments of the method 700, the determining the plurality of K2 value restrictions includes identifying an earliest PUSCH of the plurality of PUSCHs, determining a value d_{2,2} that is based on whether the DCI triggers a BWP switch in a serving cell of the earliest PUSCH, and determining each K2 value restriction of the plurality of K2 value restrictions based on the value d_{2,2}.

In some embodiments of the method 700, the determining the plurality of K2 value restrictions includes identifying a latest PUSCH of the plurality of PUSCHs, determining a value N₂ that is based on an SCS of the latest PUSCH and an SCS of the PDCCH carrying the DCI, and determining each K2 value restriction of the plurality of K2 value restrictions based on the value N₂.

In some embodiments of the method 700, the determining the plurality of K2 value restrictions includes identifying a latest PUSCH of the plurality of PUSCHs, determining a value d_{2,1}, that is based on whether a first symbol of the latest PUSCH is for a DM-RS, and determining each K2 value restriction of the plurality of K2 value restrictions based on the value d_{2,1}.

In some embodiments of the method 700, the determining the plurality of K2 value restrictions includes identifying a latest PUSCH of the plurality of PUSCHs, determining a value d₂ that is based on whether the latest PUSCH overlaps with a PUCCH and has a first priority index that is larger than a second priority index of the PUCCH and determining each K2 value restriction of the plurality of K2 value restrictions based on the value d₂.

In some embodiments of the method 700, the determining the plurality of K2 value restrictions includes identifying a latest PUSCH of the plurality of PUSCHs, determining a value d_{2,2} that is based on whether the DCI triggers a BWP switch in a serving cell of the latest PUSCH, and determining each K2 value restriction of the plurality of K2 value restrictions based on the value d_{2,2}.

In some embodiments of the method 700, the determining the plurality of K2 value restrictions includes determining a K2 value restriction of the plurality of K2 value restrictions for a corresponding PUSCH of the plurality of PUSCHs based on an offset extension corresponding to one of an SCS of the corresponding PUSCH and an SCS of the PDCCH carrying the DCI. In some such embodiments, the offset extension corresponding to the one of the SCS of the corresponding PUSCH and the SCS of the PDCCH is pre-determined. In some such embodiments, the offset extension further corresponds to a processing capability of the UE reported by the UE.

In some embodiments of the method 700, the determining whether to transmit one or more of the plurality of PUSCHs as scheduled by the DCI based on the K2 value restrictions includes identifying one or more compliant PUSCHs of the plurality of PUSCHs, wherein each of the one or more compliant PUSCHs is scheduled after the PDCCH carrying the DCI by at least the minimum permitted time indicated by its corresponding K2 value restriction, and determining to transmit the one or more compliant PUSCHs.

In some embodiments of the method 700, the determining whether to transmit one or more of the plurality of PUSCHs as scheduled by the DCI based on the K2 value restrictions includes identifying that at least one of plurality of PUSCHs is scheduled after the PDCCH carrying the DCI by less than the minimum permitted time indicated by its corresponding K2 value restriction, and determining not to transmit the plurality of PUSCHs in response to the identifying that the at least one of plurality of PUSCHs is scheduled after the PDCCH carrying the DCI by less than the minimum permitted time indicated by its corresponding K2 value restriction.

FIG. 8 illustrates a diagram 800 showing a relationship between a DCI 802 and an AP-SRS 804 that is scheduled by the DCI 802, according to embodiments herein. The DCI 802 is sent by a network in DL and received at a UE. The DCI 802 schedules 806 an AP-SRS 804 for use by the UE in UL. As illustrated, it may be understood that a time offset value 808 represents the time between the end of the DCI 802 that schedules the AP-SRS 804 and the beginning of the scheduled AP-SRS 804.

SRSs (including AP-SRSs) may have multiple possible uses. In some wireless communications systems, an SRS (e.g., an AP-SRS) may have a codebook use (denoted “codebook” herein), an antenna switching use (denoted “antennaSwitching” herein), a beam management use (denoted “beamManagement” herein), or a non-codebook use (denoted “nonCodebook” herein).

It may be that for an AP-SRS with a usage set to “codebook” or “antennaSwitching,” a minimum permitted time between a last symbol of a PDCCH carrying the DCI scheduling the AP-SRS and the first symbol of the AP-SRS is (at least) a value N₂ that is a time offset amount that is determined based on a UE processing capability according to a definition for the wireless communication system in which the UE operates, and that is based on an SCS of the scheduled AP-SRS and an SCS of a PDCCH carrying the scheduling DCI.

For AP-SRS with usage set to “beamManagement” or “nonCodebook,” a minimum permitted time between a last symbol of a PDCCH carrying the DCI scheduling the AP-SRS and the first symbol of the AP-SRS is (at least) the value N₂ plus a usage offset extension (which in some cases may be 14 symbols), where the usage offset extension may account for the time to perform beam switching and/or the time to establish a needed precoder of the AP-SRS.

It is noted that in some cases, a minimum permitted time between a last symbol of a PDCCH carrying the DCI scheduling the AP-SRS and the first symbol of the AP-SRS may further include an additional time T_{switch} representing an applicable antenna UL switching gap (if applicable).

Embodiments herein relate to the implementation of restrictions on time offset values for each of (multiple) AP-SRSs in different cells that are scheduled by a (single) DCI.

In some cases where a single DCI schedules multiple AP-SRSs in different cells, a time offset value restriction may be determined independently for each scheduled AP-SRS. These independent determinations for each AP-SRS may be based on, for example, an SCS of the scheduled AP-SRS and an SCS of the PDCCH carrying the scheduling DCI (e.g., an N₂ value calculated independently for the AP-SRS) and/or the usage of the scheduled AP-SRS (e.g., whether the usage for the AP-SRS corresponds to a usage offset extension to the minimum permitted time represented by the time offset value restriction, etc. These values may be used to determine the time offset value restriction for an AP-SRS in the manners described herein.

In other cases where a single DCI schedules multiple AP-SRSs in different cells, a time offset value restriction for each AP-SRS scheduled by the DCI may be calculated in a manner that is dependent on the timing and/or nature of other AP-SRS(s) scheduled by that DCI.

In a first alternative of dependent time offset value restriction calculation mechanisms, a largest determined value N₂ as among all AP-SRSs may be used in determinations of time offset value restrictions for each AP-SRS. For example, the UE determines an N₂ value (e.g., as described herein) for each of the AP-SRSs. Then, the UE determines a largest N₂ value from this set of N₂ values. Then, when calculating time offset value restrictions for each of the AP-SRSs scheduled by the DCI (e.g., using the methods discussed herein), this largest N₂ value is used in each such calculation for the corresponding AP-SRS.

In a second alternative of dependent time offset value restriction calculation mechanisms, a determined value N₂ of an earliest AP-SRS as among all the scheduled AP-SRSs may be used to calculate a time offset value restriction for each scheduled AP-SRS. In such cases, the UE identifies an earliest scheduled AP-SRS among all AP-SRSs scheduled by the DCI. The determination of the earliest scheduled AP-SRS may be based on the beginning locations of the AP-SRSs in some embodiments, while other embodiments may use determinations of an earliest scheduled AP-SRS based on the ending locations of the AP-SRSs. Then, the UE determines an N₂ value (e.g., as described herein) for the earliest AP-SRS. Then, when calculating time offset value restrictions for each of the AP-SRSs scheduled by the DCI (e.g., using the methods discussed herein), this N₂ value for the earliest AP-SRS is used in each such calculation for the corresponding scheduled AP-SRS.

In a third alternative of dependent time offset value restriction calculation mechanisms, a determined value N₂ of a latest AP-SRS as among all the scheduled AP-SRSs may be used to calculate a time offset value restriction for each scheduled AP-SRS. In such cases, the UE identifies a latest scheduled AP-SRS among all AP-SRSs scheduled by the DCI. The determination of the latest scheduled AP-SRS may be based on the beginning locations of the AP-SRSs in some embodiments, while other embodiments may use determinations of a latest scheduled AP-SRS based on the ending locations of the AP-SRSs. Then, the UE determines an N₂ value (e.g., as described herein) for the latest AP-SRS. Then, when calculating time offset value restrictions for each of the AP-SRSs scheduled by the DCI (e.g., using the methods discussed herein), this N₂ value for the latest AP-SRS is used in each such calculation for the corresponding scheduled AP-SRS.

In a fourth alternative of dependent time offset value restriction calculation mechanisms, the UE may determine to treat all AP-SRSs similarly as to any SRS usage-based considerations. For example, UE may determine that at least one of the plurality of AP-SRSs scheduled by the DCI is of a usage category corresponding to such a usage offset extension (e.g., at least one of the plurality of AP-SRSs has a usage set to “beamManagement” or “nonCodebook,” corresponding to a 14 symbol usage offset extension). Based on the existence of that at least one AP-SRS having such a usage category, the UE may then determine a time offset value restriction for each of the AP-SRSs in a manner that incorporates the usage offset extension.

In some cases where a single DCI schedules multiple AP-SRSs in different cells, an additional time offset may be used at the UE (e.g., to account for the additional general complexity of the multi-cell scheduling). This additional time offset may be in the form of an offset extension indicating an additional number of symbols to be counted as part of the time offset value restriction as between a PDCCH carrying the DCI and the scheduled AP-SRS (e.g., in addition to a size of a time offset value restriction that is generated by methods already discussed). This offset extension may be independently determined for each scheduled AP-SRS, based on the SCS of the scheduled AP-SRS and the SCS of the PDCCH carrying the DCI.

In some cases, this offset extension may be determined based on a pre-determined arrangement corresponding to the SCS of the scheduled AP-SRS and the SCS of the PDCCH carrying the DCI as defined for the wireless communication system.

In some cases, this offset extension may further correspond to a processing capability of the UE (e.g., where the processing capability of the UE may control the particular manner of applying the SCS of the scheduled AP-SRS and/or the SCS of the PDCCH carrying the DCI to arrive at the offset extension). The processing capability so used may be a processing capability that is/has been reported to the network.

In cases where a single DCI schedules multiple AP-SRSs in different cells, it may be that the UE determines whether (or not) to transmit one or more of the AP-SRSs based on the time offset value restrictions for the AP-SRSs.

In a first such cases, the UE may identify one or more compliant AP-SRSs of the plurality of AP-SRSs, where each compliant AP-SRS is an AP-SRS that is scheduled (e.g., according to its time offset value) after the PDCCH carrying the DCI by at least the minimum permitted time indicated by the time offset value restriction corresponding to the AP-SRS. Then the UE may proceed to transmit the one or more compliant AP-SRSs. The UE may further identify non-compliant AP-SRSs, where each non-compliant AP-SRS is an AP-SRS that is scheduled (e.g., according to its time offset value) after the PDCCH carrying the DCI by less than the minimum permitted time indicated by the time offset value restriction corresponding to the AP-SRS. The UE may not transmit these non-compliant AP-SRSs.

In second such cases, the UE may identify one or more non-compliant AP-SRSs, where each non-compliant AP-SRS is an AP-SRS that is scheduled (e.g., according to its time offset value) after the PDCCH carrying the DCI by less than the minimum permitted time indicated by the time offset value restriction corresponding to the AP-SRS. In this second case, it may be that the UE may not transmit any of the AP-SRSs scheduled by the DCI (e.g., even dropping those AP-SRS(s) that are compliant as discussed above (if any)) as a response to the identification of the one or more non-compliant AP-SRSs.

It is noted that similar considerations may apply in the case of scheduling multiple PDSCHs in different cells by a single DCI.

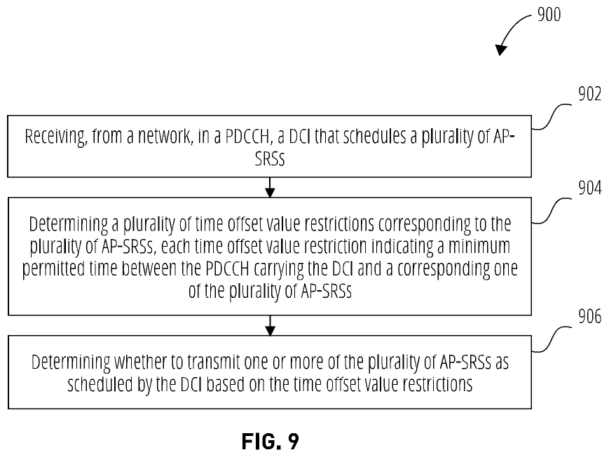

FIG. 9 illustrates a method 900 of a UE, according to embodiments herein. The method 900 includes receiving 902, from a network, in a PDCCH, a DCI that schedules a plurality of AP-SRSs.

The method 900 further includes determining 904, a plurality of time offset value restrictions corresponding to the plurality of AP-SRSs, each time offset value restriction indicating a minimum permitted time between the PDCCH carrying the DCI and a corresponding one of the plurality of AP-SRSs.

The method 900 further includes determining 906 whether to transmit one or more of the plurality of AP-SRSs as scheduled by the DCI based on the time offset value restrictions.

In some embodiments of the method 900, the determining the plurality of time offset value restrictions includes determining a time offset value restriction of the plurality of time offset value restrictions for a corresponding AP-SRS of the plurality of AP-SRSs based on a value N₂ that is determined based on an SCS of the corresponding AP-SRS and an SCS of the PDCCH carrying the DCI, and a usage category of the corresponding AP-SRS.

In some embodiments of the method 900, the determining the plurality of time offset value restrictions includes determining a time offset value restriction of the plurality of time offset value restrictions for a corresponding AP-SRS of the plurality of AP-SRSs based on an offset extension corresponding to one of an SCS of the corresponding AP-SRS and an SCS of the PDCCH carrying the DCI. In some such embodiments, the offset extension corresponding to the one of the SCS of the corresponding AP-SRS and the SCS of the PDCCH is pre-determined. In some such embodiments, the offset extension further corresponds to a processing capability of the UE reported by the UE.

In some embodiments of the method 900, the determining the plurality of time offset value restrictions includes determining a set of values N₂ corresponding to the plurality of AP-SRSs, wherein each value N₂ is based on a SCS of one of the plurality of AP-SRSs and an SCS of the PDCCH carrying the DCI, determining a largest value N₂ from among the set of values N₂, and determining each time offset value restriction of the plurality of time offset value restrictions based on the largest value N₂ from among the set of values N₂.

In some embodiments of the method 900, the determining the plurality of time offset value restrictions includes identifying an earliest AP-SRS of the plurality of AP-SRSs, determining a value N₂ that is based on an SCS of the earliest AP-SRS and an SCS of the PDCCH carrying the DCI, and determining each time offset value restriction of the plurality of time offset value restrictions based on the value N₂.

In some embodiments of the method 900, the determining the plurality of time offset value restrictions includes identifying a latest AP-SRS of the plurality of AP-SRSs, determining a value N₂ that is based on an SCS of the latest AP-SRS and an SCS of the PDCCH carrying the DCI, and determining each time offset value restriction of the plurality of time offset value restrictions based on the value N₂.

In some embodiments of the method 900, the determining the plurality of time offset value restrictions includes determining that at least one of the plurality of AP-SRSs is of a usage category corresponding to an offset extension and determining each time offset value restriction of the plurality of time offset value restrictions based on the offset extension.

In some embodiments of the method 900, the determining whether to transmit one or more of the plurality of AP-SRSs scheduled by the DCI based on the timing offset values includes identifying one or more compliant AP-SRSs of the plurality of AP-SRSs, wherein each of the one or more compliant AP-SRSs is scheduled after the DCI by at least the minimum permitted time indicated by its corresponding timing offset value, and determining to transmit the one or more compliant AP-SRSs.

In some embodiments of the method 900, the determining whether to transmit one or more of the plurality of AP-SRSs as scheduled by the DCI based on the timing offset values includes identifying that at least one of the plurality of AP-SRSs is scheduled after the DCI by less than the minimum permitted time indicated by its corresponding timing offset value, and determining not to transmit any of the plurality of AP-SRSs in response to the identifying that the at least one of the plurality of AP-SRSs is scheduled after the DCI by less than the minimum permitted time indicated by its corresponding timing offset value.

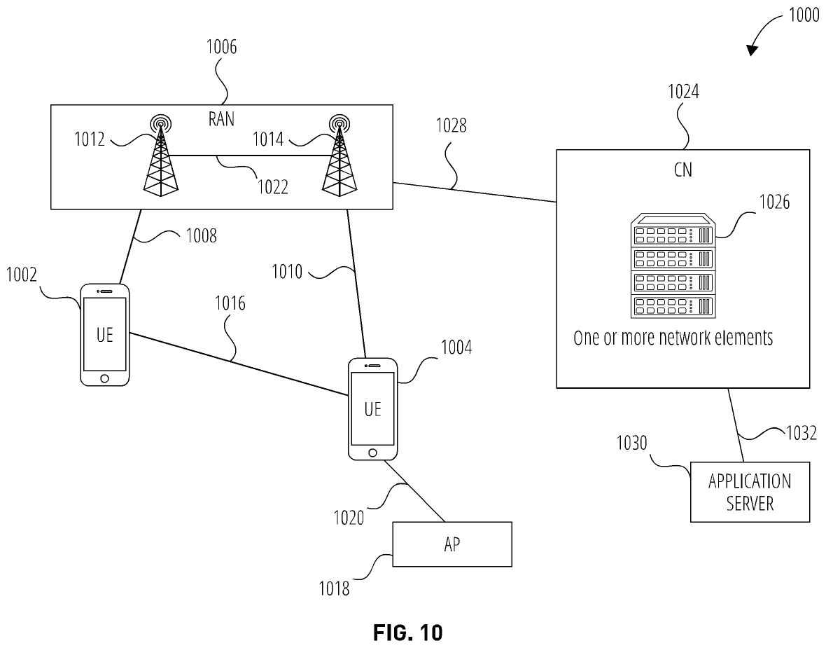

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations (such as base station 1012 and base station 1014) that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi© router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VoIP sessions, group communication sessions, etc.) for the UE 1002 and UE 1004 via the CN 1024. The application server 1030 may communicate with the CN 1024 through an IP communications interface 1032.

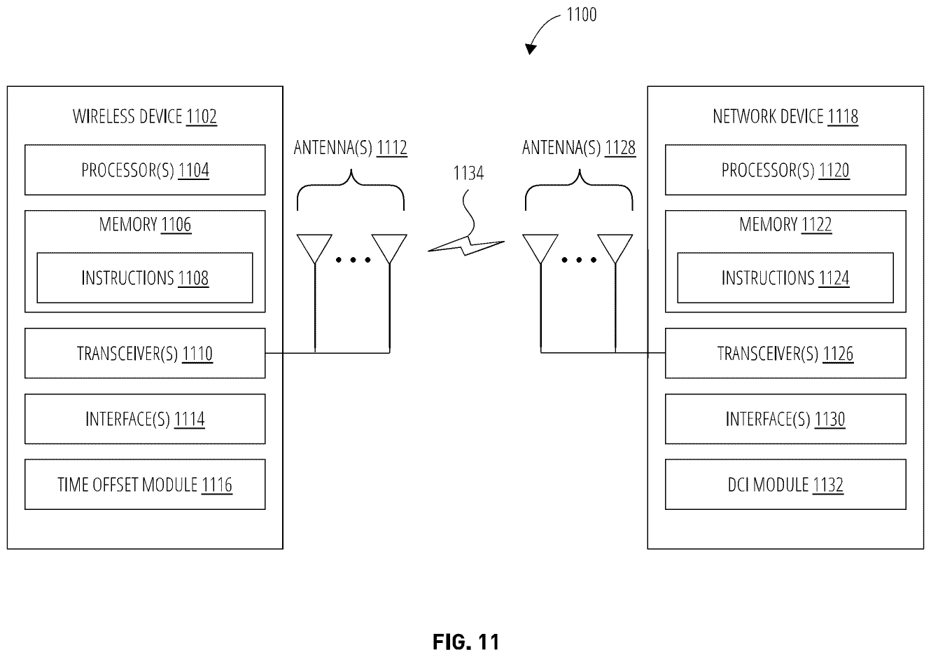

FIG. 11 illustrates a system 1100 for performing signaling 1134 between a wireless device 1102 and a network device 1118, according to embodiments disclosed herein. The system 1100 may be a portion of a wireless communications system as herein described. The wireless device 1102 may be, for example, a UE of a wireless communication system. The network device 1118 may be, for example, a base station (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter and/or receiver circuitry that use the antenna(s) 1112 of the wireless device 1102 to facilitate signaling (e.g., the signaling 1134) to and/or from the wireless device 1102 with other devices (e.g., the network device 1118) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1110/antenna(s) 1112 already described) that allow for communication between the UE and other devices and may operate according to known protocols (e.g., Wi-Fi©, Bluetooth®, and the like).

The wireless device 1102 may include a time offset module 1116. The time offset module 1116 may be implemented via hardware, software, or combinations thereof. For example, the time offset module 1116 may be implemented as a processor, circuit, and/or instructions 1108 stored in the memory 1106 and executed by the processor(s) 1104. In some examples, the time offset module 1116 may be integrated within the processor(s) 1104 and/or the transceiver(s) 1110. For example, the time offset module 1116 may be implemented by a combination of software components (e.g., executed by a DSP or a general processor) and hardware components (e.g., logic gates and circuitry) within the processor(s) 1104 or the transceiver(s) 1110.

The time offset module 1116 may be used for various aspects of the present disclosure, for example, aspects of FIG. 5 through FIG. 9. The time offset module 1116 is configured to, for example, determine and apply one or more K2 value restrictions for multiple PUSCHs scheduled on multiple cells by a single DCI and/or to determine and apply time offset value restrictions for multiple AP-SRSs scheduled on multiple cells by a single DCI, as described herein.

The network device 1118 may include one or more processor(s) 1120. The processor(s) 1120 may execute instructions such that various operations of the network device 1118 are performed, as described herein. The processor(s) 1120 may include one or more baseband processors implemented using, for example, a CPU, a DSP, an ASIC, a controller, an FPGA device, another hardware device, a firmware device, or any combination thereof configured to perform the operations described herein.

The network device 1118 may include a memory 1122. The memory 1122 may be a non-transitory computer-readable storage medium that stores instructions 1124 (which may include, for example, the instructions being executed by the processor(s) 1120). The instructions 1124 may also be referred to as program code or a computer program. The memory 1122 may also store data used by, and results computed by, the processor(s) 1120.

The network device 1118 may include one or more transceiver(s) 1126 that may include RF transmitter and/or receiver circuitry that use the antenna(s) 1128 of the network device 1118 to facilitate signaling (e.g., the signaling 1134) to and/or from the network device 1118 with other devices (e.g., the wireless device 1102) according to corresponding RATs.

The network device 1118 may include one or more antenna(s) 1128 (e.g., one, two, four, or more). In embodiments having multiple antenna(s) 1128, the network device 1118 may perform MIMO, digital beamforming, analog beamforming, beam steering, etc., as has been described.

The network device 1118 may include one or more interface(s) 1130. The interface(s) 1130 may be used to provide input to or output from the network device 1118. For example, a network device 1118 that is a base station may include interface(s) 1130 made up of transmitters, receivers, and other circuitry (e.g., other than the transceiver(s) 1126/antenna(s) 1128 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1118 may include a DCI module 1132. The DCI module 1132 may be implemented via hardware, software, or combinations thereof. For example, the DCI module 1132 may be implemented as a processor, circuit, and/or instructions 1124 stored in the memory 1122 and executed by the processor(s) 1120. In some examples, the DCI module 1132 may be integrated within the processor(s) 1120 and/or the transceiver(s) 1126. For example, the DCI module 1132 may be implemented by a combination of software components (e.g., executed by a DSP or a general processor) and hardware components (e.g., logic gates and circuitry) within the processor(s) 1120 or the transceiver(s) 1126.

The DCI module 1132 may be used for various aspects of the present disclosure, for example, aspects of FIG. 5 through FIG. 9. The DCI module 1132 is configured to, for example, generate and or transmit (e.g., via the transceiver(s) 1126 and the antenna(s) 1128) a DCI that schedules multiple PUSCHs on multiple cells and/or that schedules multiple AP-SRSs on multiple cells, as is described herein.

Embodiments contemplated herein include an apparatus comprising means to perform one or more elements of any of the method 700 or the method 900. This apparatus may be, for example, an apparatus of a UE (such as a wireless device 1102 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 700 or the method 900. This non-transitory computer-readable media may be, for example, a memory of a UE (such as a memory 1106 of a wireless device 1102 that is a UE, as described herein).

Embodiments contemplated herein include an apparatus comprising logic, modules, or circuitry to perform one or more elements of any of the method 700 or the method 900. This apparatus may be, for example, an apparatus of a UE (such as a wireless device 1102 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 700 or the method 900. This apparatus may be, for example, an apparatus of a UE (such as a wireless device 1102 that is a UE, as described herein).

Embodiments contemplated herein include a signal as described in or related to one or more elements of any of the method 700 or the method 900.

Embodiments contemplated herein include a computer program or computer program product comprising instructions, wherein execution of the program by a processor is to cause the processor to carry out one or more elements of any of the method 700 or the method 900. The processor may be a processor of a UE (such as a processor(s) 1104 of a wireless device 1102 that is a UE, as described herein). These instructions may be, for example, located in the processor and/or on a memory of the UE (such as a memory 1106 of a wireless device 1102 that is a UE, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, in a physical downlink control channel (PDCCH), a downlink control information (DCI) that schedules a plurality of physical uplink shared channels (PUSCHs);
determining a plurality of K2 value restrictions corresponding to the plurality of PUSCHs, each K2 value restriction indicating a minimum permitted time between the PDCCH carrying the DCI and a corresponding one of the plurality of PUSCHs; and
determining whether to transmit one or more of the plurality of PUSCHs as scheduled by the DCI based on the K2 value restrictions.

2. The method of claim 1, wherein the determining the plurality of K2 value restrictions comprises determining a K2 value restriction of the plurality of K2 value restrictions for a corresponding PUSCH of the plurality of PUSCHs based on:
a value N₂ that is determined based on a subcarrier spacing (SCS) of the corresponding PUSCH and an SCS of the PDCCH carrying the DCI;
a value d_{2,1} that is determined based on whether a first symbol of the corresponding PUSCH is for a demodulation reference signal (DM-RS); and
a value d₂ that is determined based on whether the corresponding PUSCH overlaps with a physical uplink control channel (PUCCH) and has a first priority index that is larger than a second priority index of the PUCCH.

3. The method of claim 1, wherein the determining the plurality of K2 value restrictions comprises:
determining a set of values N₂ corresponding to the plurality of PUSCHs, wherein each value N₂ is based on a subcarrier spacing (SCS) of one of the plurality of PUSCHs and an SCS of the PDCCH carrying the DCI;
determining a largest value N₂ from among the set of values N₂; and
determining each K2 value restriction of the plurality of K2 value restrictions based on the largest value N₂ from among the set of values N₂.

4. The method of claim 1, wherein the determining the plurality of K2 value restrictions comprises:
determining a set of values d_{2,1} corresponding to the plurality of PUSCHs, wherein each value d_{2,1} is based on whether a first symbol of one of the plurality of PUSCHs is for a demodulation reference signal (DM-RS);
determining a largest value d_{2,1} from among the set of values d_{2,1}; and
determining each K2 value restriction of the plurality of K2 value restrictions based on the largest value d_{2,1} from among the set of values d_{2,1}.

5. The method of claim 1, wherein the determining the plurality of K2 value restrictions comprises:
determining a set of values d₂ corresponding to the plurality of PUSCHs, wherein each value d₂ is based on whether one of the plurality of PUSCHs overlaps with a physical uplink control channel (PUCCH) and has a first priority index that is larger than a second priority index of the PUCCH;
determining a largest value d₂ from among the set of values d₂; and
determining each K2 value restriction of the plurality of K2 value restrictions based on the largest value d₂ from among the set of values d₂.

6. The method of claim 1, wherein the determining the plurality of K2 value restrictions comprises:
determining a set of values d_{2,3} corresponding to the plurality of PUSCHs, wherein each value d_{2,3} is based on whether the DCI triggers a bandwidth part (BWP) switch in a serving cell of one of the plurality of PUSCHs;
determining a largest value d_{2,3} from among the set of values d_{2,2}; and
determining each K2 value restriction of the plurality of K2 value restrictions based on the largest value d_{2,3} from among the set of values d_{2,2}.

7. The method of claim 1, wherein the determining the plurality of K2 value restrictions comprises:
identifying an earliest PUSCH of the plurality of PUSCHs;
determining a value N₂ that is based on a subcarrier spacing (SCS) of the earliest PUSCH and an SCS of the PDCCH carrying the DCI; and
determining each K2 value restriction of the plurality of K2 value restrictions based on the value N₂.

8. The method of claim 1, wherein the determining the plurality of K2 value restrictions comprises:
identifying an earliest PUSCH of the plurality of PUSCHs;
determining a value d_{2,1} that is based on whether a first symbol of the earliest PUSCH is for a demodulation reference signal (DM-RS); and
determining each K2 value restriction of the plurality of K2 value restrictions based on the value d_{2,1}.

9. The method of claim 1, wherein the determining the plurality of K2 value restrictions comprises:
identifying an earliest PUSCH of the plurality of PUSCHs;
determining a value d₂ that is based on whether the earliest PUSCH overlaps with a physical uplink control channel (PUCCH) and has a first priority index that is larger than a second priority index of the PUCCH; and
determining each K2 value restriction of the plurality of K2 value restrictions based on the value d₂.

10. The method of claim 1, wherein the determining the plurality of K2 value restrictions comprises:
identifying an earliest PUSCH of the plurality of PUSCHs;
determining a value d_{2,2} that is based on whether the DCI triggers a bandwidth part (BWP) switch in a serving cell of the earliest PUSCH; and
determining each K2 value restriction of the plurality of K2 value restrictions based on the value d_{2,2}.

11. The method of claim 1, wherein the determining the plurality of K2 value restrictions comprises:
identifying a latest PUSCH of the plurality of PUSCHs;
determining a value N₂ that is based on a subcarrier spacing (SCS) of the latest PUSCH and an SCS of the PDCCH carrying the DCI; and
determining each K2 value restriction of the plurality of K2 value restrictions based on the value N₂.

12. The method of claim 1, wherein the determining the plurality of K2 value restrictions comprises:
identifying a latest PUSCH of the plurality of PUSCHs;
determining a value d_{2,1} that is based on whether a first symbol of the latest PUSCH is for a demodulation reference signal (DM-RS); and
determining each K2 value restriction of the plurality of K2 value restrictions based on the value d_{2,1}.

13. The method of claim 1, wherein the determining the plurality of K2 value restrictions comprises:
identifying a latest PUSCH of the plurality of PUSCHs;
determining a value d₂ that is based on whether the latest PUSCH overlaps with a physical uplink control channel (PUCCH) and has a first priority index that is larger than a second priority index of the PUCCH; and
determining each K2 value restriction of the plurality of K2 value restrictions based on the value d₂.

14. The method of claim 1, wherein the determining the plurality of K2 value restrictions comprises:
identifying a latest PUSCH of the plurality of PUSCHs;
determining a value d_{2,3} that is based on whether the DCI triggers a bandwidth part (BWP) switch in a serving cell of the latest PUSCH; and
determining each K2 value restriction of the plurality of K2 value restrictions based on the value d_{2,2}.

15. The method of claim 1, wherein the determining the plurality of K2 value restrictions comprises determining a K2 value restriction of the plurality of K2 value restrictions for a corresponding PUSCH of the plurality of PUSCHs based on an offset extension corresponding to one of a subcarrier spacing (SCS) of the corresponding PUSCH and an SCS of the PDCCH carrying the DCI.

16. The method of claim 15, wherein the offset extension corresponding to the one of the SCS of the corresponding PUSCH and the SCS of the PDCCH is pre-determined.

17. The method of claim 15, wherein the offset extension further corresponds to a processing capability of the UE reported by the UE.

18. The method of claim 1, wherein the determining whether to transmit one or more of the plurality of PUSCHs as scheduled by the DCI based on the K2 value restrictions comprises:
identifying one or more compliant PUSCHs of the plurality of PUSCHs, wherein each of the one or more compliant PUSCHs is scheduled after the PDCCH carrying the DCI by at least the minimum permitted time indicated by its corresponding K2 value restriction; and
determining to transmit the one or more compliant PUSCHs.

19. The method of claim 1, wherein the determining whether to transmit one or more of the plurality of PUSCHs as scheduled by the DCI based on the K2 value restrictions comprises:
identifying that at least one of plurality of PUSCHs is scheduled after the PDCCH carrying the DCI by less than the minimum permitted time indicated by its corresponding K2 value restriction; and
determining not to transmit the plurality of PUSCHs in response to the identifying that the at least one of plurality of PUSCHs is scheduled after the PDCCH carrying the DCI by less than the minimum permitted time indicated by its corresponding K2 value restriction.

20. A method of a user equipment (UE), comprising:
receiving, from a network, in a physical downlink control channel (PDCCH), a downlink control information (DCI) that schedules a plurality of aperiodic sounding reference signals (AP-SRSs);
determining a plurality of time offset value restrictions corresponding to the plurality of AP-SRSs, each time offset value restriction indicating a minimum permitted time between the PDCCH carrying the DCI and a corresponding one of the plurality of AP-SRSs; and
determining whether to transmit one or more of the plurality of AP-SRSs as scheduled by the DCI based on the time offset value restrictions.

21-33. (canceled)
